(19) United States
(12) Patent Application Publication
(10) Pub. No.: US 2008/0121087 A1
(43) Pub. Date: May 29, 2008

(54) Fret-Board Wrap

(76) Inventor: Brian Rees, New South Wales (AU)

Correspondence Address: MICHAEL MOLINS;MOLINS & CO., SUITE 5, LEVEL 6, 139 MACQUARIE ST, SYDNEY NSW, 2000, omitted

(21) Appl. No.: 11/667,469

(22) PCT Filed: Nov. 15, 2005
(86) PCT No.: PCT/AU05/01739

§ 371 Date: May 10, 2007

(30) Foreign Application Priority Data
Nov. 15, 2004 (AU) 2004906516

(51) Int. Cl. G10D 1/08

(52) U.S. Cl. 84/314 R

(57) ABSTRACT

A visual interface or guide is provided for a fretted, stringed musical instrument. It has two or more guide strips that fit between the neck and the strings of the instrument. Adjacent guide strips have a gap or opening between them that can receive a fret. Visual indications on one or more of the strips indicate finger placements for the user. In some embodiments, guide strips are interconnected by an elastic medium and have a spacing apart from one another that is adjustable. Various methods for attaching the guide to an instrument are disclosed.

### FIELD OF THE INVENTION

The invention relates to fretted instrument teaching aids and more particularly to a fingering guide that expands, at least in one dimension.

### BACKGROUND OF THE INVENTION

The guitar and other fretted instruments can be difficult instruments to learn. This is at least partially due to the lack of a simple and easily understood visual interface to the instrument.

However, having to learn only five common or basic fretting patterns to use the full instrument makes the guitar a relatively simple instrument to play. It is the blank or relatively featureless interface of the fret-board (common to most fretted instruments) that makes the initial navigation of the guitar so difficult.

Needed is a guide that serves as a visual interface to a fretted instrument. It is preferred that the guide act as a visual indicator for finger placement that (a) can be removed when required, (b) that is adaptable to a reasonable range of different sizes and brands and types of instruments, and (c) can be used in different positions along the fret board of a given instrument.

It will be understood that the invention will be disclosed with reference to its implementation with a fretted six string guitar but that these same teachings make the invention applicable to a wide range of fretted instruments and even, with some increase in inconvenience, to non-fretted instruments. Although, the main examples relate to a device having five visual guide strips that are used together in any of a number of ways, having more or fewer guide strips are well within the scope of the invention.

The invention provides a number of potential benefits to the user. With respect to a guitar, it assists in locating and learning the five fretting patterns for playing the notes of the major and minor scales or indeed any scale. Thus, the invention may also be used to indicate or reveal chord shapes. The invention also helps explain and remove the confusion behind how five fretting positions lead to the playing of the seven principal modes. The invention helps teach or illustrate that when playing across the fret board (and while remaining within the boundaries of one of the five fret positions) the user completes a little more than two octaves of notes. The invention thus shows the user the natural way that four fingers use the appropriate local four or five frets to play across the fret board. Further, the invention helps explain how the instrument changes key.

### OBJECTS AND SUMMARY OF THE INVENTION

It is an object of the invention to provide a visual fingering guide to a fretted instrument.

The object is met by providing a guide comprising two or more guide strips that are adapted to fit between the neck and the strings of a fretted instrument. Adjacent guide strips have a gap or opening between them that can receive a fret. Visual indications on one or more of the strips indicate finger placements for the user.

In some embodiments, guide strips are interconnected and have a spacing apart from one another that is adjustable.

In some embodiments of the invention, the strips are elastic in a transverse direction.

Various methods for attaching the guide to an instrument are disclosed.

### BRIEF DESCRIPTION OF THE DRAWING FIGURES

In order that the invention be better understood, reference will be made to the following drawing figures in which:

FIG. 1 is a cross section through a neck of a guitar illustrating the location of a guide according to the teachings of the present invention;

FIG. 2 is a cross section of a guitar neck illustrating how the guide is temporarily affixed to the neck;

FIG. 3 is a plan view of a guitar neck illustrating one embodiment of the guide of the present invention;

FIG. 4 is a top plan view of a guitar neck illustrating the relocation of the guide depicted in FIG. 3;

FIG. 5 is a top plan view of a guitar neck illustrating a second embodiment of the invention;

FIG. 6 is a top plan view of a guitar neck illustrating a companion lower guide for the guide depicted in FIG. 5;

FIG. 7 is an end elevation illustrating an alternate method of neck attachment using a hook and loop type fastener;

FIG. 8 is an end elevation showing an alternate way of fastening a guide to a neck;

FIG. 9 is an end elevation illustrating another method of guide fastening;

FIG. 10 is an end elevation illustrating a further method of guide fastening;

FIG. 11 is a side elevation illustrating yet another method of guide fastening;

FIG. 12 is a side elevation illustrating another method of guide fastening;

FIG. 13 is a side perspective illustrating another way of fastening a guide to a neck;

FIG. 14 is a side elevation showing an arched interconnection between guide strips;

FIG. 15 is a side elevation showing the interconnection of FIG. 14 in a compressed state;

FIG. 16 illustrates the use of elastic material in the interconnection of guide strips;

FIG. 17 is a side elevation illustrating diagonal interconnection between guide strips;

FIG. 18 is a side elevation showing individual guide strips;

FIG. 19 is a side elevation illustrating guide strips interconnected by a strip to which they are attached by hook and loop fasteners;

FIG. 20 is a side elevation partially broken away showing nested guide strips;

FIG. 21 is a side elevation illustrating the interconnection of guide strips with a perforated strip;

FIG. 22 is a side elevation illustrating the interconnection of guide strips with a folding or concertina mechanism;

FIG. 23 is a perspective view of another embodiment of the present invention utilising guide rods;

FIG. 24 is a perspective view illustrating the way that guide strips are carried by guide rods;

FIG. 25 is an end elevation illustrating the clamping mechanism of FIG. 23;

FIG. 26 is a perspective view of a device assembled in accordance with FIGS. 23-25;

FIGS. 27(a)-(d) are side elevations illustrating different guide strip profiles; and

FIG. 28 is a perspective view of an alternate embodiment of the invention that utilizes guide rods to carry individual guide strips.

### BEST MODE AND OTHER EMBODIMENTS OF THE INVENTION

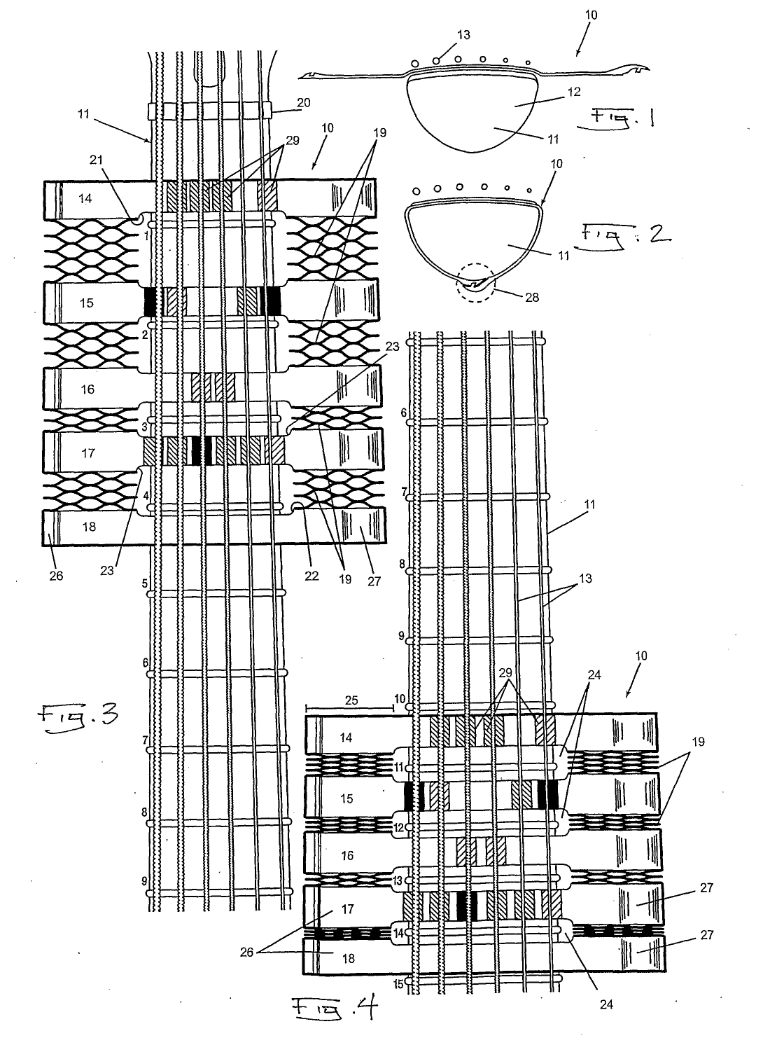

As shown in FIGS. 1-4, a guide 10 is used to provide a visual interface to a stringed, fretted instrument such as a guitar 11. The guide 10 comprises a flat, flexible substrate that can be inserted between and that fits between the neck of the instrument 12 and the strings 13 and wrapped around the neck. In this particular example, and as shown in FIGS. 3 and 4, the guide 10 comprises 5 individual guide strips 14-18 that are spaced apart but interconnected by a flexible, expanding medium such as a mesh 19.

As suggested by FIGS. 3 and 4, the guide strips 14-18 are adapted to provide variable spacing between one another owing to the action of the mesh 19. The guide strips 14-18 are at their widest spacing, as suggested by FIG. 3, when they are inserted at the top of the neck 12. In the examples of FIGS. 3 and 4, the neck is seen as having spaced apart frets numbered 1-15. As suggested by FIG. 3, the uppermost guide strip 14 can be located between the guitar's nut 20 and the first fret 1. Note that the outer or terminal guide strips 14, 18 have inwardly directed recess areas 21-22 and that the interior guide strips 15, 16, 17 have co-operating transverse recess areas 23. In use, the recess areas 21, 22, 23 cooperate to form gaps 24 (as shown in FIG. 4) that are able to better accommodate the frets when the guide strips are close together.

In preferred embodiments, the expanding mesh 19 does not extend across the full width of the guide 10 because it would interfere with the action of the frets. Instead, the mesh 19 is provided between strips 14-18 at locations on either side to define a gap that receives the neck 11.

The expanding mesh portions 19 are provided so that the longitudinal spacing between the strips 14-18 can be adjusted, as required. As shown in FIG. 3, the spacing between the strips 14-18 is greater at the top of the neck where the frets are furthest apart than it is in FIG. 4 where the guide 10 is located between the lower frets 11-15. It will be appreciated that this expanding mechanism utilising mesh 19 (or other methods as will be explained) may be used to position the guide 10 along any five consecutive frets from the top of the neck to the bottom.

When the guide 10 is its intended position, the opposite side or lateral edges 26, 27 are brought together and joined, for example, as shown in FIG. 2 with the use of a cooperating “snap action” bead and detent mechanism 28.

In particularly preferred embodiments of the device suggested by FIGS. 1-4, the material from which the guide strips 14-18 are fabricated from is also elastic in a transverse direction. Providing this form of transverse elasticity accounts for instruments having tapered necks. As suggested by FIG. 3, the top of the neck is narrower than the bottom. Thus, a guide strip 14 may be imprinted or otherwise marked with visible indicators 29 that have a particular spacing in an unstretched condition. When installed at the bottom of the neck, as shown in FIG. 4, the spacing between the indicators 29 can be increased by stretching the material of the guide strips during installation. Thus, the length of the guide strips and hence spacing between the indicators 29 is greater when the device is used at the bottom of the neck than it is when the device is used at the top of the neck.

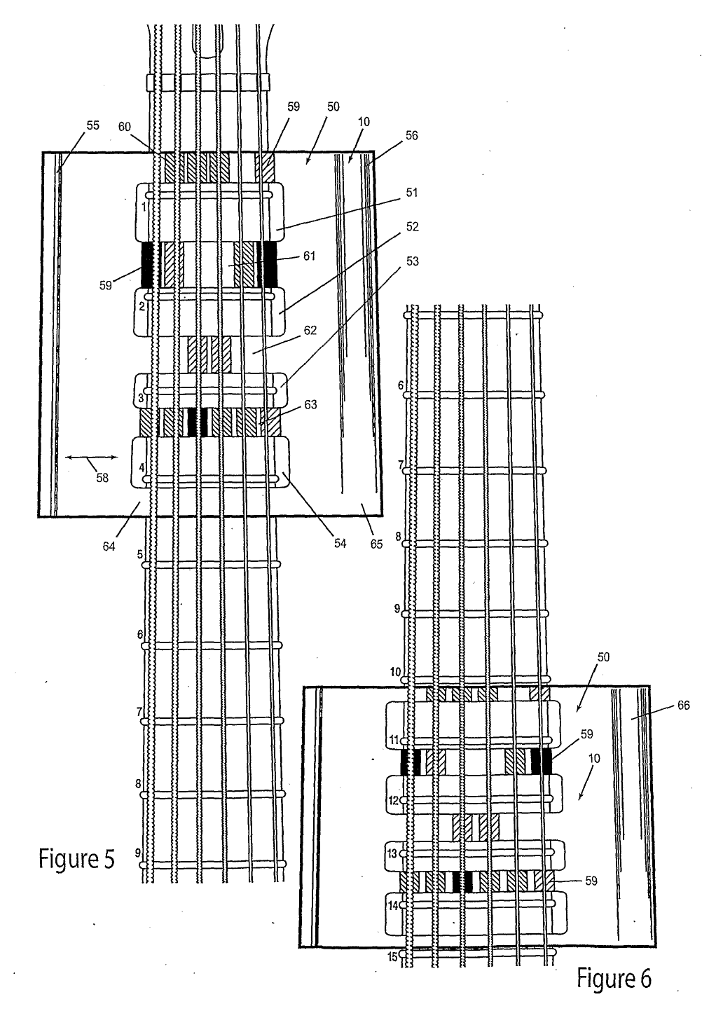

A second embodiment of the invention is depicted in FIGS. 5 and 6. In this embodiment, the flexible substrate 50 comprises a single sheet with integral guide strips 60-64, separated by fret openings 51-54. It can wrap around the neck and be affixed to itself. The guide strips carry the visual indications of finger positions 59. Each of the lateral edges 55, 56 are equipped with means of being attached to one another using, for example, the mechanism disclosed with reference to FIG. 2, or other suitable means. The substrate 50 may be somewhat elastic in transverse direction 58. This allows the substrate 50 to stretch to accommodate the way that the neck increases in width toward the bottom. The spacing and longitudinal dimensions of the fret openings 51 are such that a pair of only slightly different devices (65 in FIG. 5 and its companion 66 in FIG. 6) are required to span the entire length of the fret board. One device 65 accommodates the top 10 frets (or so) and the bottom or companion device 66 is usable on the remaining lower frets (say frets 9-16).

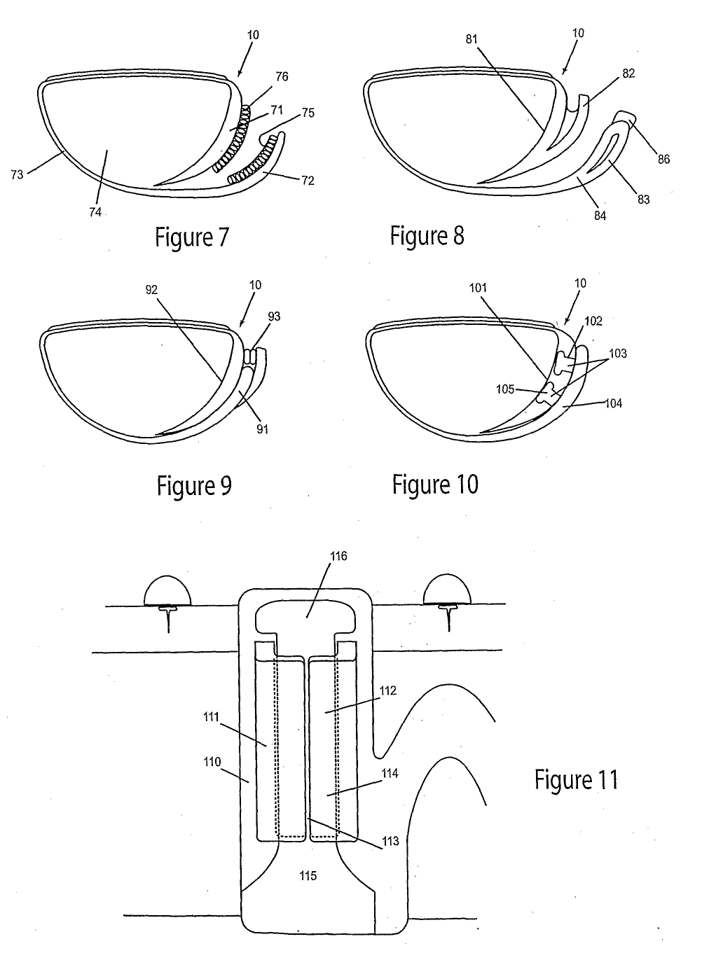

It will be appreciated that the guides 10 suggested by FIGS. 1-6 need to be both affixable and removable from the neck of an instrument. They must be applied to the neck in a way that prevents them from moving excessively when in use but that also allows them to be removed easily when the user wishes to do so. FIGS. 7-13 illustrate a variety of fastenings by which a guide can be affixed to the neck of a threaded instrument. It will be appreciated that these same methods may be equally suitable for individual guide strips in those examples where the strips are not interconnected to one another in any way.

As shown in FIG. 7, the overlapping edges 71, 72 of a substrate 73 forming a guide 10 make contact when wrapped around the neck 74. The overlapping edges or ends 71, 72 are brought together using cooperating segments of hook and loop fastener 75, 76.

As shown in FIG. 8, one edge 81 of a guide substrate is provided with a hook 82 that is able to engage an elasticized loop 83 formed by (or joined to) the opposite edge 84 of the guide. A finger tab 86 allows the user to conveniently extend the loop 83 over the hook 82, equally facilitating removal of the loop 83 from the hook 82 when required.

A similar fastening arrangement is depicted in FIG. 9, however, the outer edge 91 is fastened to the inner edge 92 of the guide 10 by a mechanical fastener such as a “snap” fastener 93, it being understood that one half of the fastener is carried by each edge of the guide.

As shown in FIG. 10, one edge 101 of the guide 10 may be enlarged in thickness and provided with recesses 102. The recesses are adapted to receive studs 103 that are formed into or attached to the opposite edge 104 of the guide 10. The enlarged heads 105 of the studs are adapted to enter the recesses 102, 103 and thus frictionally resist withdrawal until extracted by the action of the user.

As shown in FIG. 11, the interior 110 of the overlapping edges of a guide or guide strip is provided with a pair of “L-shaped” flanges 111, 112. The flanges 111, 112 face one another to define a gap 113 between them. The elevated edges 114 of the flanges 111, 112 define a channel beneath them that is adapted to receive an elastic tongue 115 that is affixed to the opposite edge of the guide. When stretched, the elastic tongue 115 can be introduced into the gap 113 and located in the channel a shown. Because the tongue 115 has an enlarged head 116 it is prevented from being withdrawn into the channel and thus keeps the guide or guide strip snug on the neck.

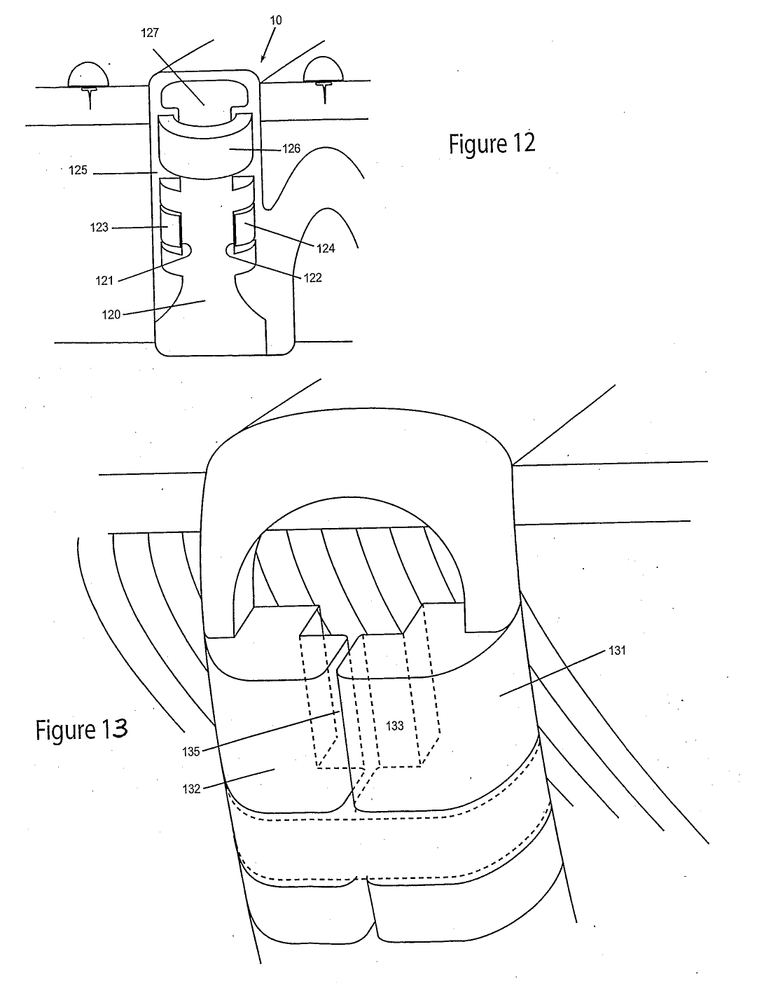

Variations of the fastening mechanism depicted in FIG. 11 are shown in FIGS. 12 and 13. In FIG. 12 the tongue 120 is shown as having lateral notches 121, 122 formed along its side edges. These notches 121, 122 engage upright teeth 123, 124 that are integral with the inner edge 125 of the overlapping edges of the guide or guide strip. The tongue 120 fits underneath a bracket 126 formed on the inner edge 125 and is prevented from inadvertent withdrawal by its own enlarged head 127. The interaction between the notches 121, 122 and fixed teeth 123, 124 act to resist the elastic strain in the tongue 120 when it is under tension.

Another example is depicted in FIG. 13. In this example, the flanges 131, 132 that retain the tongue cooperate to form a pocket 133. The pocket 133 formed by the cooperating recesses in the flanges 131, 132 is capable of receiving an enlargement formed in or onto the elastic tongue and thus serves as a way of retain the tongue until it is withdrawn by tensioning it to the point where the enlargement is pulled out of the pocket 133, thereby allowing the tongue to be withdrawn from the gap 135 between the flanges 131, 132.

FIGS. 3 and 4 were used to illustrate a method of providing longitudinal elasticity between the guide strips 14-18. It will be appreciated that a variety of other mechanism are adapted to serve this same purpose. FIGS. 14-26 illustrate a number of other means by which the spacing between adjacent guide strips can be adjusted.

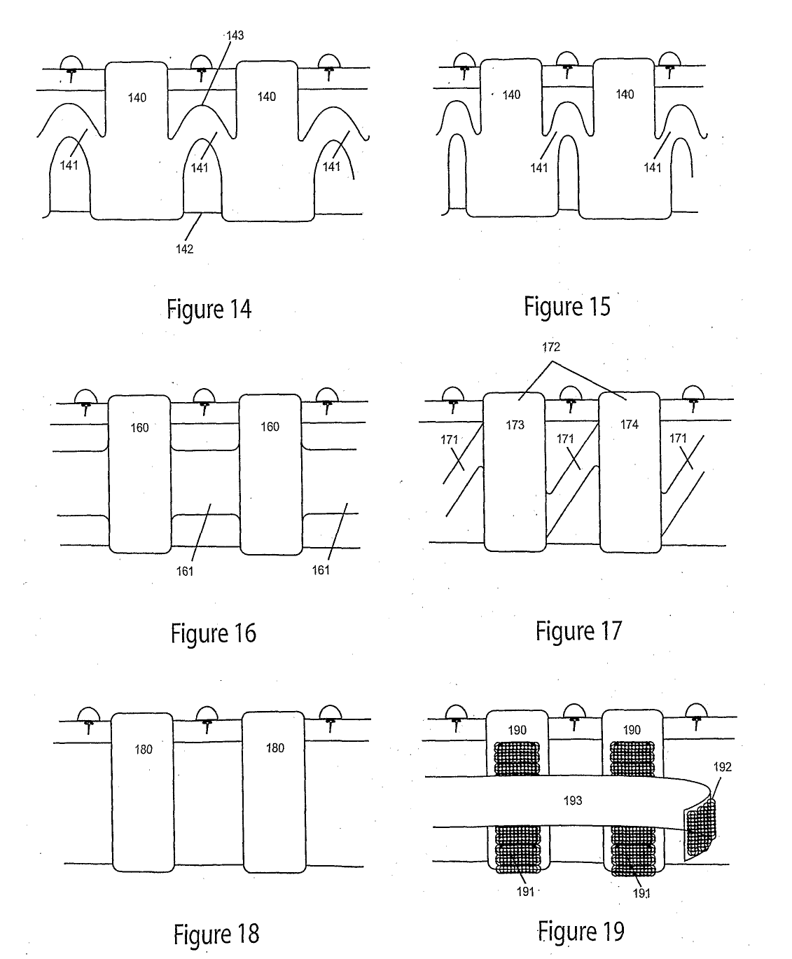

As shown in FIG. 14, adjacent guide strips 140 are interconnected by integral spring-like arches 141. Note that the arches extend upward from the lowest portion of the neck 142 and reach a peak 143 located approximately midway between adjacent guide strips 140. As shown in FIG. 15, the strips 140 can be brought together or compressed by distorting the arches 141.

As shown in FIG. 16, adjacent guide strips 160 may be interconnected by portions of elastic material 161. Elastomers such as urethane or other natural or synthetic rubbers may be used for this purpose.

As shown in FIG. 17, diagonal struts 171 may be used to interconnect adjacent guide strips 172. In this example, the diagonal struts 171 extend from a lower or central portion of one strip 173 to an upper portion of an adjacent strip 174.

In FIG. 18, it is illustrated that individual guide strips 180 (preferably in a set of 5) may be affixed to a neck, between frets, in any convention fashion or by utilizing any of the methods disclosed in the present specification. Strictly speaking, the guide strips 180 need not be interconnected or attached to one another although the use of the device is made more convenient when the guide strips are interconnected.

As shown in FIG. 19, the interconnection between adjacent guide strips 190 can be affected by providing each guide strip 190 with one half of a hook and loop type fastener system 191. The other half of the hook and loop type fastener system 192 is affixed to a connecting strip 193. Thus, the spacing between adjacent guide strips 190 is easily achievable and yet the collection of guide strips 190 and the connecting strip 193 is easy to remove and reinsert.

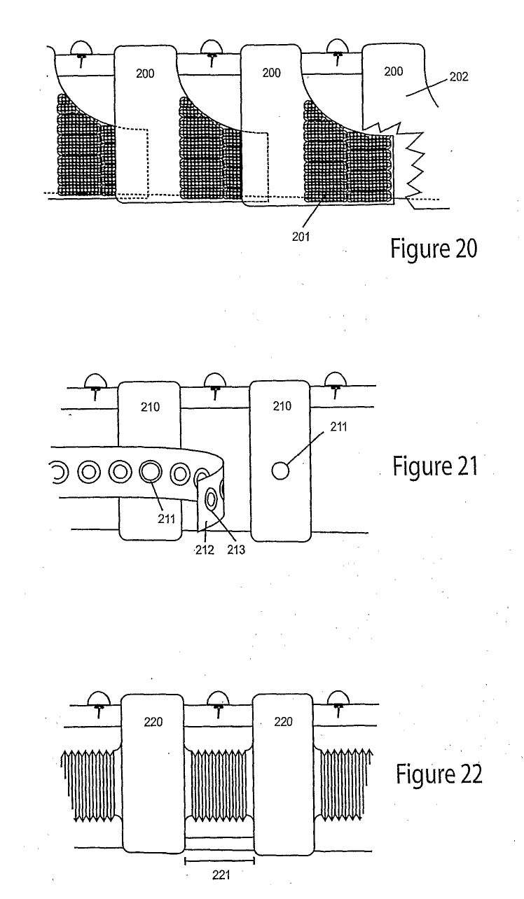

A hook and loop type fastener system is also used in the example provided by FIG. 20. In this example, the individual guide strips 200 are formed to include a sleeve or extension 201. The sleeve 201 extends toward an adjacent strip and is insertable beneath an adjacent guide strip 202. By providing a hook and loop type fastener system between adjacent strips 200 the collection of strips may be removed as an assembly and reinserted when required.

Another means of interconnecting adjacent guide strips is illustrated in FIG. 21. In this example, guide strips 210 are each provided with a pin or stud 211. Also provided is a band 212 having perforations, through openings or recesses 213 that engage with the studs 211.

As shown in FIG. 22, adjacent guide strips 220 are interconnected by a folded or concertina portions 221. The concertina portions 221 expand and contract by folding, thus allowing the spacing between adjacent guide strips 220 to be altered.

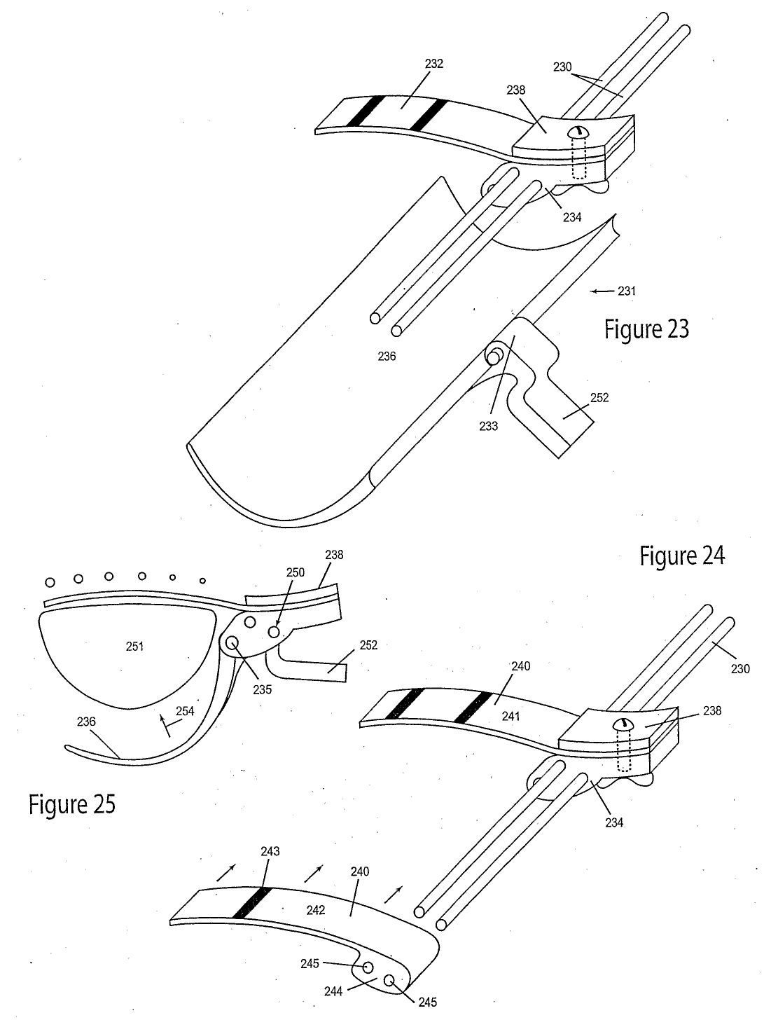

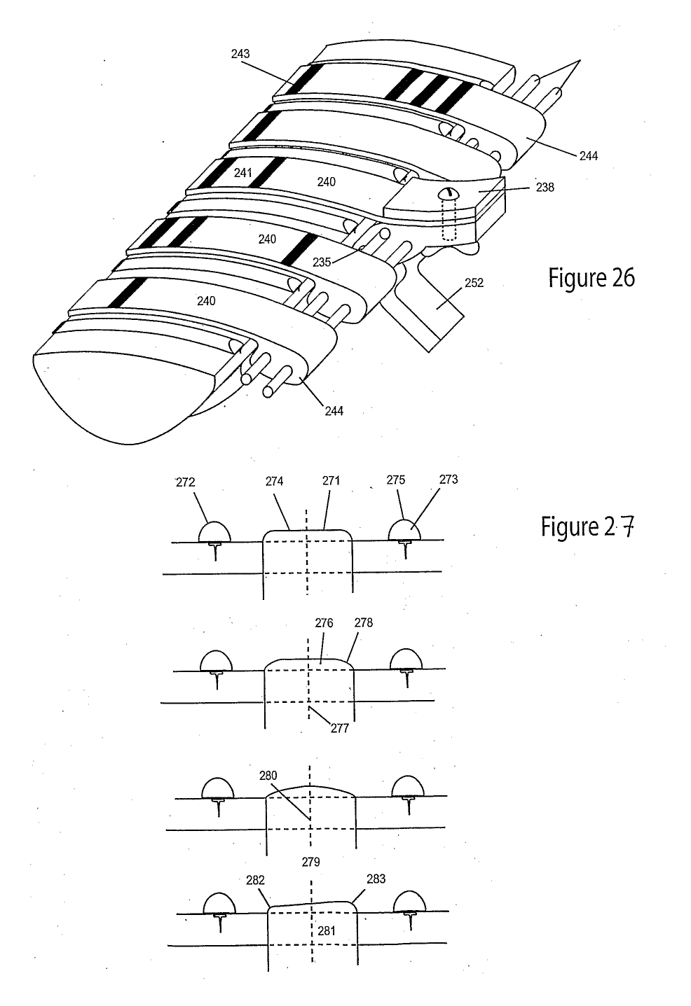

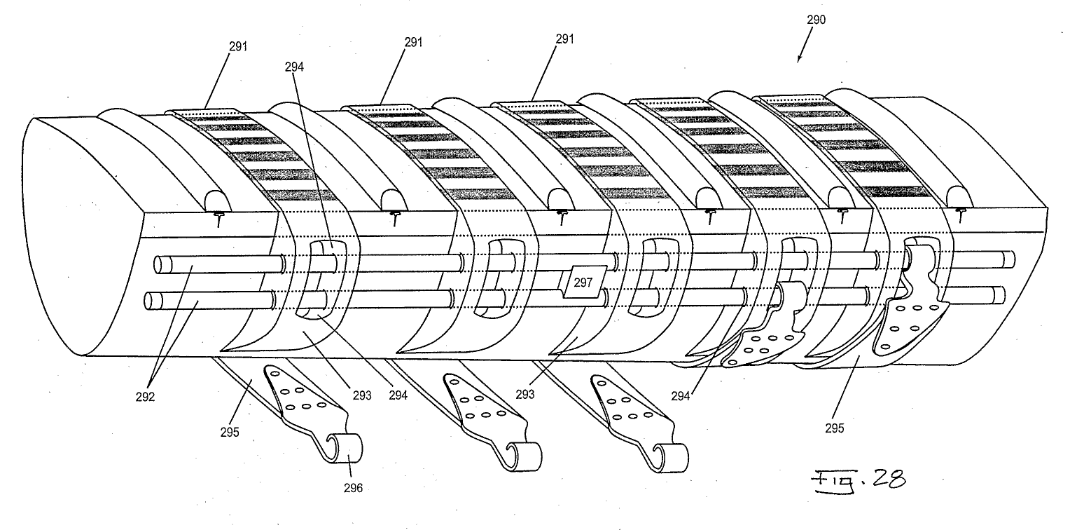

Another means of adjustably interconnecting guide strips so as to form a unified assembly as depicted in FIGS. 23-26. As shown in FIG. 23, the assembly comprises a pair of generally parallel guide rods 230 and a neck clamp 231 that attaches to one of the guide strips 232. In preferred embodiments, the neck clamp 231 further comprises a hinge portion 233 that engages a cooperating hinge portion formed on a hinge block 234 that is carried by one of the guide rods 230. Thus, the hinge portion 233 and its cooperating counterpart form the hinge 235 of a spring loaded clamping mechanism 250 depicted in FIG. 25. The neck clamp 231 further includes an elongated channel-like contact portion 236 that is adapted to engage the underside of an instrument neck 251. A grip 252 extends from the clamp 231 in a manner that finger pressure can be exerted between the grip 252 and the upper surface 238 of the hinge block 234 thus allowing the hinge 235 to be opened against the bias of a spring (not shown). Releasing the finger pressure allows the clamp 236 to travel in a direction of the arrow 254 (see FIG. 25). When the hinge is closed, the guide is essentially immobilized with respect to the neck 251. Because the guide rods 230 extend from either side of the block 234, they can be used to retain additional guide strips 240 as shown in FIG. 24. As suggested by FIG. 24, the central one of the five guide strips 241 is intended to remain engaged with the pair of guide rods 230. The additional removable guide strips 242 each include a blade carrying appropriate indicators or markings 243 and each includes an enlarged end 244 having a pair of through openings 245 for slidably receiving the guide rods 230. This allows the additional strips 242 to be carried by the guide rods 230 in a way that allows the spacing between strips to be easily adjusted and maintained. A perspective view illustrating the completed assembly is depicted in FIG. 26.

While the guide strips and substrate have generally been disclosed and referred to as being essentially flat, it will be understood that the profile of guide strips, (being those portions between the frets) may be advantageously configured. FIG. 27(a) illustrates a flat guide strip 271 that fits between adjacent frets 272, 273. The upper and lower surfaces of the guide strip are generally parallel and the upper surface of the guide strip 274 is below the upper extremity 275 of each of the adjacent frets. The sliding action of a finger over the frets and over the guide strips may be enhanced by tapering the transverse edges of the guide strip as shown in FIG. 27(b). In this example, the guide strip 276 is generally symmetrical about its midline 277, having transverse edges 278 that present little or no end face. Note that the central portion of the guide strip 276 is generally flat. A domed guide strip is illustrated in FIG. 27(c). In this example, the guide strip 279 has a thickest portion along its midline 280 and decreases in thickness as the guide strip extends longitudinally toward each of the adjacent frets. Another example is depicted in FIG. 27(d). In this example, the guide strip 281 is tapered from a minimum thickness 282 along the edge closest to the instrument's nut, to a maximum thickness 283 adjacent the opposite parallel edge. Thus, the guide strip 281 when viewed in the transverse direction, forms a ramp that increases in thickness in the direction away from the nut.

A further embodiment of the invention is depicted in FIG. 28. In this example, the guide 290 comprises individual guide strips 291 that are substantially the same in construction and each connected to a pair of generally parallel guide rods 292. As illustrated, each guide strip 291 includes an enlarged end 293 having longitudinal through openings 294 that are adapted to receive the guide rods 292. Each enlarged end 293 also includes a transverse opening, pocket or recess 294 through which the guide rods 292 are both visible and accessible. The end of the guide strip 291 opposite the enlarged ends 293 comprises an elasticized portion has an elasticized portion 295 attached to it. The elasticized portion 295 has attached to it a rigid hook 296 that can be inserted into the opening 294 and that can be attached to one or both of the rods 292. If required, the two rods 292 can be attached to one another by a connector 297. In this way two or more guide strips can be carried by the parallel rods in a way that allows them to be used repeatedly at a given spacing or for that spacing to be altered according to the needs of the user.

In preferred embodiments of the invention, the guide strips are preferably either transparent or the same colour as the neck of a particular instrument. In this way, visual distractions caused by the contrasting appearance of the strips over the neck are avoided. In order that the visible indicators (e.g. 29 in FIG. 3) are easily seen, they should be printed on or etched into the guide strips in a colour that contrasts with the colour of the neck. The visible indicators can be printed or etched into the underside of a guide strip so that they are not worn off by the action of the fingers and strings on the upper surfaces of the guide strips.

As previously mentioned, the guides of the present invention are preferably sold in sets of five, one corresponding to each of the five basic fretting or fingering patterns. When make in accordance with the teachings of FIGS. 3 and 4, each of the guides may be used at any position along the entire length of the neck. Where the guides are not elastic in the longitudinal direction, it may be necessary to provide two or more sets of guides (see FIGS. 5 and 6) so that the variable spacing between frets, along the length of the neck, may be accommodated.

While the present invention has been disclosed with reference to particular details of construction these should be understood as having been provided by way of example and not as limitations to the scope or spirit of the invention.

What is claimed is:

1. A guide for a fretted string instrument having a neck, comprising:
a plurality of guide strips separated from one another by fret openings;
adjacent guide strips being attached to one another by elastic portions; and
a fastening for affixing the guide strips to the neck.

2. The guide of claim 1, wherein:
the elastic portion between adjacent guide strips defines a gap for receiving the neck.

3. The guide of claim 1, wherein:
the elastic portions comprise a mesh.

4. The guide of claim 1, wherein:
a guide strip further comprises a recess area for accommodating a fret.

5. The guide of claim 1, wherein:
the guide has edges that cooperate to join to one another to fasten the guide to the neck.

6. The guide of claim 1, wherein:
the guide is elastic in a transverse direction.

7. The guide of claim 1, wherein:
the elastic portions comprise spring-like arches.

8. The guide of claim 1, wherein:
the elastic portions comprise concertina portions.

9. The guide of claim 1, wherein:
the guide is flexible enough to wrap around the neck.

10. A guide for a fretted instrument having a neck, comprising:
a flexible substrate having guide strips separated from one another by fret openings, the guide strips carrying visual indicators of finger positions, the guide being removeably affixable to the neck in a plurality of positions along the neck.

11. The guide of claim 10, further comprising:
a second companion guide that comprises a flexible substrate having guide strips separated from one another by fret openings, the guide strips carrying visual indicators of finger positions, the guide being removeably affixable to the neck in a plurality of positions along the neck.

12. The guide of claim 10, wherein:
the guide is affixable to the neck by a portion of a mechanical fastener carried by each of a pair of opposite edges of the guide.

13. The guide of claim 12, wherein:
the mechanical fastener further comprises a hook and loop type fastener.

14. The guide of claim 12, wherein:
the mechanical fastener further comprises a hook and elastic loop.

15. The guide of claim 12, wherein:
the mechanical fastener further comprises a recess and stud arrangement.

16. The guide of claim 12, wherein:
the mechanical fastener further comprises an arrangement of elastic strap with an enlarged head that cooperates with and is retained by a channel.

17. A guide for a fretted instrument having a neck, comprising:
a plurality of guide strips that are carried by one or more longitudinal guide rods;
the guide strips carrying visual indications of finger positions.

18. The guide of claim 17, wherein:
the spacing between the guide strips on the one or more guide rods is variable and adjustable.

19. The guide of claim 17, wherein:
the rods carry a clamp assembly for attaching the guide to the neck.

20. The guide of claim 17, wherein:
each guide strip carries a fastener that is independently affixable to the neck.
